(19) United States
(12) Patent Application Publication
(10) Pub. No.: US 2017/0286775 A1
(43) Pub. Date: Oct. 5, 2017

(54) METHOD AND DEVICE FOR DETECTING VIOLENT CONTENTS IN A VIDEO , AND STORAGE MEDIUM

(71) Applicants: Le Holdings(Beijing)Co., Ltd., Beijing (CN); LE SHI ZHI XIN ELECTRONIC TECHNOLOGY (TIAN JIN) LIMITED, Tianjin (CN)

(72) Inventor: Wei Cai, Tianjin (CN)

(21) Appl. No.: 15/247,765

(22) Filed: Aug. 25, 2016

Related U.S. Application Data
(63) Continuation of application No. PCT/CN2016/088980, filed on Jul. 6, 2016.

(30) Foreign Application Priority Data
Mar. 29, 2016 (CN) 201610189188.8

(51) Int. Cl. G06K 9/00; G06K 9/62; G06K 9/46; G06K 9/52; G06T 7/20; G06T 7/40

(52) U.S. Cl. CPC G06K 9/00718; G06T 7/20; G06K 9/00335; G06T 7/408; G06K 9/4652; G06K 9/4642; G06K 9/52; G06K 9/6215; G06K 9/00765

(57) ABSTRACT

Embodiments of the disclosure provide a method and device for detecting violent contents in a video, and a non-transitory computer-readable storage medium. The method for detecting violent contents in a video includes: determining an average shot length of any scene in the video to be detected, and an average motion intensity of the shot in the scene; and extracting feature data of a number of elements in the scene upon determining that the average shot length is below a first preset threshold, and/or the average motion intensity of the shot is above a second preset threshold, and determining that there are violent contents in the video to be detected upon determining that the feature data of at least one element among the extracted feature data of the elements lie in a range of feature data of the element extracted in advance from a specific scene.

### CROSS-REFERENCE TO RELATED APPLICATIONS

This application is a continuation of International Application No. PCT/CN2016/088980, filed on Jul. 6, 2016, which is based upon and claims priority to Chinese Patent Application No. 201610189188.8, filed on Mar. 29, 2016, the entire contents of which are incorporated herein by reference.

### TECHNICAL FIELD

The disclosure relates to the field of communications, and particularly to a method and device for detecting violent contents in a video, and a storage medium.

### BACKGROUND

A violent content refers to a type of special intense content, and a violent scene generally occurs in the majority of movies and teleplays to typically draw the attention of their watchers; and the violent content in the movie can be detected automatically to thereby search the movie for some contents, to review and post-process the movies, etc. For example, the movie can be rated as function of the amount of detected violent contents, and those scenes inappropriate for children to watch can be filtered or masked.

The inventors have identified during making of the disclosure that the violent content in a video is generally detected by analyzing the video using only some information feature, so it may be difficult to achieve a satisfactory effect, particularly as follows:

In a first approach, the average motion amount and duration of the video is determined by searching the video for reoccurring scenes with a small amount of similar visible contents, and the video is categorized as a function of the average motion amount and the duration of the video, where it may be difficult to distinguish a violent scene from a sporting program with a large amount of motions; and

In a second approach, sound tracks in the video are analyzed for the violent content in the video, and since there is often significant noise and a variety of similar sound accompanying the audio in the video, the violent content may be misjudged frequently.

The inventors have identified during making of the disclosure that the violent content in the video may not be detected accurately based upon the average motion amount and duration of the video, or by analyzing the sound tracks, thus resulting in a high misjudgment ratio.

### SUMMARY

Embodiments of the disclosure provide a method and apparatus for detecting violent content in a video, and a storage medium so as to address the problem in the prior art of a high misjudgment ratio in detecting the violent contents in the video so as to improve the accuracy of detecting the violent contents in the video.

In one aspect, an embodiment of the disclosure provides a method for detecting violent contents in a video, the method including: at an electronic device:determining an average shot length of any scene in the video to be detected, and an average motion intensity of the shot in the scene; and extracting feature data of a number of elements in the scene upon determining that the average shot length is below a first preset threshold, and/or the average motion intensity of the shot is above a second preset threshold, and determining that there are violent contents in the video to be detected upon determining that the feature data of at least one element among the extracted feature data of the elements lie in a range of feature data of the element extracted in advance from a specific scene.

In another aspect, an embodiment of the disclosure provides an electronic device, the electronic device including

at least one processor; and

a memory communicably connected with the at least one processor for storing instructions executable by the at least one processor, wherein execution of the instructions by the at least one processor causes the at least one processor to:

determine an average shot length of any scene in the video to be detected, and an average motion intensity of a shot in the scene; and

extract feature data of a number of elements in the scene upon determining that the average shot length is below a first preset threshold, and/or the average motion intensity of the shot is above a second preset threshold, and determine that there are violent contents in the video to be detected upon determining that the feature data of at least one element among the extracted feature data of the elements lie in a range of feature data of the element extracted in advance from a specific scene.

In another aspect, an embodiment of the disclosure provides a non-transitory computer-readable storage medium storing executable instructions that, when executed by an electronic device with a touch-sensitive display, cause the electronic device to:

determine an average shot length of any scene in the video to be detected, and an average motion intensity of a shot in the scene; and

extract feature data of a number of elements in the scene upon determining that the average shot length is below a first preset threshold, and/or the average motion intensity of the shot is above a second preset threshold, and determine that there are violent contents in the video to be detected upon determining that the feature data of at least one element among the extracted feature data of the elements lie in a range of feature data of the element extracted in advance from a specific scene.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic flow chart of a method for detecting violent contents in a video in accordance with some embodiments.

FIG. 2 is a schematic flow chart of a particular flow of a method for detecting violent contents in a video in accordance with some embodiments;

FIG. 3 is a schematic structural diagram of an apparatus for detecting violent contents in a video in accordance with some embodiments;

FIG. 4 is a schematic structural diagram of an electronic device in accordance with some embodiments.

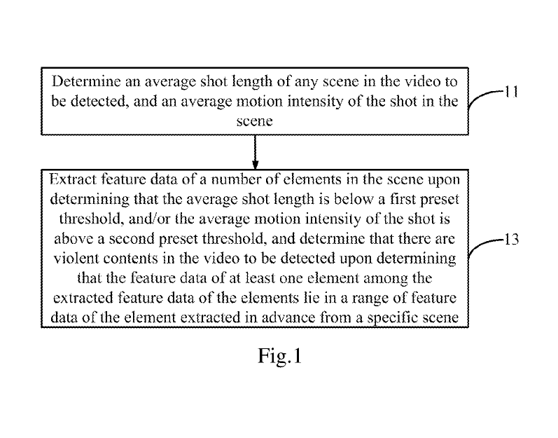

### DETAILED DESCRIPTION

In order to make the objects, technical solutions, and advantages of the embodiments of the disclosure more apparent, the technical solutions according to the embodiments of the disclosure will be described below clearly and fully with reference to the drawings in the embodiments of the disclosure, and apparently the embodiments described below are only a part but not all of the embodiments of the disclosure. Based upon the embodiments here of the disclosure, all the other embodiments which can occur to those skilled in the art without any inventive effort shall fall into the scope of the disclosure.

As illustrated, a method for detecting violent contents in a video according to an embodiment of the disclosure includes:

The step 11 is to determine an average shot length of any scene in the video to be detected, and an average motion intensity of the shot in the scene; and

The step 13 is to extract feature data of a number of elements in the scene upon determining that the average shot length is below a first preset threshold, and/or the average motion intensity of the shot is above a second preset threshold, and to determine that there are violent contents in the video to be detected upon determining that the feature data of at least one element among the extracted feature data of the elements lie in a range of feature data of the element extracted in advance from a specific scene.

In the method according to the embodiment of the disclosure, firstly the average shot length of any scene in the video to be detected, and the average motion intensity of the shot in the scene are determined; the feature data of the elements in the scene are further extracted upon determining that the average shot length is below the first preset threshold, and/or the average motion intensity of the shot is above the second preset threshold; and it is determined that there are violent contents in the video to be detected upon determining that the feature data of at least one element among the extracted feature data of the elements lie in the range of feature data of the element extracted in advance from the specific scene (e.g., a violent scene). As compared with the prior art in which violent contents are detected based upon the average motion amount and duration of the video, or by analyzing the sound tracks, the feature data of the elements in the scene are extracted, and it is determined that there are violent contents in the video to be detected upon determining that the feature data of at least one element among the extracted feature data of the elements lie in the range of feature data of the element extracted in advance from the specific scene (e.g., a violent scene), so that violent contents can be detected with respect to the feature data of the elements in the scene to thereby improve the accuracy of detecting violent contents in the video.

It shall be noted that there is some person or object in such a rapid and significant motion in the majority of violent contents that is generally reflected by shot cut of a video continuously in a short period of time, so the average shot length in the scene is used as a criterion to detect violent contents in the scene; and the motion intensity of the shot is determined by spatial variation in the shot, and the durations of the shot, so the average motion intensity of the shot is used as another criterion to detect violent contents in the scene, so that each scene in the video is filtered in advance based upon these two criterions, that is, firstly the average shot length of any scene in the video to be detected, and the average motion intensity of the shot in the scene are determined; and it is determined that there may be violent contents in the scene, and the scene is added to candidate scene for further detection upon determining that the average shot length is below the first preset threshold, and/or the average motion intensity of the shot is above the second preset threshold, where the first preset threshold and the second preset threshold can be preset empirically, for example, if the value of the first preset threshold is 3, and the value of the second preset threshold is ⅙ of the area of a picture in the video, then if the average shot length in any scene is less than 3 seconds, and/or the average motion intensity of the shot in the scene is more than ⅙ of the area of a picture in the video, then the scene will be determined as a candidate scene.

In a particular implementation, the motion intensity in the shot is determined by the spatial variation in the shot, and the duration of the shot, and in order to measure effectively a motion feature in the video, firstly motion sequences in the shot are extracted. The extracting are particularly by firstly performing two-dimension wavelet decomposition on video data to generate a series of spatially reduced grayscale images of video frames, and then performing wavelet transformation and filtering on temporal variations of grayscales of respective pixels in these images to generate a group of motion sequence images, where the spatial variation of an object in motion in the video can be obtained using such a wavelet analysis, and there are non-zero values of the resulting motion sequence images on the boundary of the object in motion; and also the complexity of calculation can be lowered.

Next the motion intensities of the respective shots are calculated in the equation of:

$$SS = \frac{1}{T} {\sum }_{i = b + 1}^{e} \{ {\sum }_{m , n} \vert {m}_{l}^{k} ( m , n ) \vert \} ,$$

Where mₗ^{k}(m,n) represents the i-th frame in the k-th shot of the motion sequence images of the current scene, where m and n represent horizontal and vertical resolutions of the motion sequence images, b and e represent start frame number and end frame number of the k-th shot, and T represents the length T=e−b of the k-th shot. As can be apparent from the equation above, there is a higher motion intensity of a shot with a shorter duration and including a larger amount of motions, and after the motion intensities of the respective shots are calculated, the average motion intensity of the shot is equal to the ratio of the sum of the motion intensities of all the shots in the scene to the total number of shots in the scene.

In a particular implementation, the average length of the scenes in the scene is equal to the ratio of the total length of time of the scene to the number of scenes in the scene. For example, if the total length of time of a scene is 300 seconds, and there are pictures of 5 scenes in the scene, then the average length of the scenes will be 60 seconds.

In a particular implementation, after the candidate scene is determined according to the average shot length in the scene, and/or the average motion intensity of the shot, in order to improve the accuracy of detection, the candidate scene is further detected, the feature data of the elements in the candidate scene are extracted, it is determined whether the feature data of each element in the candidate scene lie in the range of feature data of the element extracted in advance from the specific scene, and it is determined that there are violent contents in the video to be detected upon determining that the feature data of at least one element among the extracted feature data of the elements lie in the range of feature data of the element extracted in advance from the specific scene, where the specific scene can be some known scene including violent contents, e.g., a firing scene, an exploding scene, a blooding scene, etc. The feature data of the elements include image feature data of each frame of picture in the scene, and audio feature data in the scene.

Particularly the feature data of the elements are extracted in advance from a number of specific scenes including violent contents, the range of feature data of each element is obtained, and when the feature data of any one or more elements among the feature data of the elements extracted from the candidate scene lie in the range or ranges of feature data corresponding to the element or elements, then it can be determined that there are violent contents in the candidate scene. Based upon the average shot length, and the average motion intensity of the shot, with respect to the feature data of the elements in the scene, if the feature data of the elements include the image feature data of each frame of picture, and the audio feature data in the scene then the visible feature and the audible feature can be detected together to thereby improve the accuracy of detection.

Of course, those skilled in the art shall appreciate that if there are a larger number of elements with their feature data among the feature data of the elements extracted from the candidate scene lying in the ranges of feature data of those elements extracted from the specific scene, then the accuracy of detection will be higher; and of course, if there is only one element with the feature data thereof among the feature data of the elements extracted from the candidate scene lying in the range of feature data of the corresponding element extracted from the specific scene, then it can also be determined that there are violent contents in the candidate scene.

In a particular embodiment, a firing scene and an exploding scene are the most apparent scenes including violent contents, and these scenes are characterized by some unique sound and image features in a movie; and visible features, i.e., image features, are detected primarily as instantaneous flames arising from firing and exploding.

In a possible implementation, in the method according to the embodiment of the disclosure, the image feature data of each frame of picture include a color histogram of each frame of picture; and when the feature data of the elements include the image feature data of each frame of picture in the scene, then it will be determined whether the image feature data of each frame of picture lie in a range of image feature data of the picture extracted in advance from the specific scene by extracting for each frame of picture in the scene the color histogram of the frame of picture, and determining that the image feature data of the frame of picture lie in the range of image feature data of the picture extracted in advance from the specific scene upon determining that the counted amounts of a preset number of colors in the color histogram of the frame of picture lie in ranges of counted amounts of the corresponding colors in a color histogram of the picture extracted from the specific scene.

In a particular implementation, a flame arising from exploding lasts a longer period of time and covers a larger area on a screen than that of firing, but both of the flames arising from firing and exploding are characterized by a color histogram with a dominating color of yellow, orange, or red, so a color template including ranges of respective colors is defined in advance, the color histogram of the candidate scene is compared with the color template defined in advance, and when the counted amount of the yellow, orange, or red color in the color histogram of the candidate scene lies in the range of counted amount of the corresponding color in the color template defined in advance, then a flame occurring in the scene, and thus violent contents in the candidate scene will be detected.

In a scene including violent contents, some violent behaviors (e.g., firing, perforating using a sword, exploding, etc.) typically come with a blooding event; and in a particular implementation, it can be determined from the color histogram whether there is a color of blood in the scene. However there are many colors similar to the color of blood in reality, it will not be sufficient if the occurrence of a blooding event is determined only from the number of pixels in the color of blood in a picture of the scene, but the occurrence of a blooding event will be further determined with respect to the numbers of pixels in the color of blood in a number of adjacent frames of pictures, particularly as follows:

In a possible implementation, in the method according to the embodiment of the disclosure, after it is determined that the counted amounts of the preset number of colors in the color histogram of the frame of picture lie in the ranges of counted amounts of the corresponding colors in the color histogram of the picture extracted from the specific scene, the method further includes determining the counted amounts of the preset number of colors in a number of frames of pictures adjacent to the frame of picture; and it is determined that the image feature data of the frame of picture lie in the range of image feature data of the picture extracted in advance from the specific scene by determining that the image feature data of the frame of picture lie in the range of image feature data of the picture extracted in advance from the specific scene upon determining that the counted number of each one of the preset number of colors in the frame of picture and the adjacent frames of pictures is increasing gradually in a time order of the frames of pictures.

In a particular implementation, it is determined whether there is a blooding event by counting the numbers of pixels in the color of blood in the adjacent frames of pictures, and determining that there may be a blooding event occurring only if there are a significantly increasing number of pixels in the color of blood in a short period of time, that is, if the number of pixels in the color of blood in the consecutive frames of pictures is increasing gradually in a time order of the frames of pictures, then it will be determined that there may be a blooding event occurring.

It may be difficult to detect violent contents in the video by analyzing only the visible features, but violent contents in the video shall be further detected by analyzing other features. Sound is an important component in the video, so the audible features can assist a watcher in understanding the contents of the video, where specific sound can draw the attention of the watcher directly and rapidly. In an embodiment of the disclosure, the audio data can be analyzed to assist in detecting violent contents.

In a possible implementation, in the method according to the embodiment of the disclosure, the audio feature data include a sample vector and a covariance matrix of the audio data; and if the feature data of the elements include the audio feature data in the scene, then it will be determined whether the audio feature data in the scene lie in a range of audio feature data extracted in advance from the specific scene by calculating the sample vector and the covariance matrix of the audio data in the scene, and determining that the audio feature data in the scene lie in the range of audio feature data extracted in advance from the specific scene upon determining that the similarity between the sample vector and the covariance matrix of the audio data in the scene, and a sample vector and a covariance matrix of the audio data extracted in advance from the specific scene is above a third preset threshold.

Generally a scene including violent contents are frequently accompanied by some special sound other than voice (e.g., exploding sound, screaming sound, firing sound, cracking sound of glass, etc) and special background music. The accompany audio in the video is categorized into violent sound and non-violent sound for a further analysis using a Gaussian model, where the Gaussian model can simplify the complexity of calculation, and all the parameters thereof can be determined by mean vector and covariance matrix of the sample vector.

In a particular implementation, a large number of videos are searched for a scene including violent contents, where sound tracks in the videos are determined as sound samples, sample vector(s) is/are obtained by temporally sampling the sound samples, and covariance matrixes are obtained as compact representations of the temporal variations, so that the candidate scene is detected for violent contents by calculating the mean vector and the covariance matrix of the audio data in the candidate scene so that the similarity between the audio data in the candidate scene, and the sound sample can be determined as a function of the similarity between the mean vector and the covariance matrix in the candidate scene, and the mean vector and the covariance matrix of the sound sample, and if the similarity between the mean vector and the covariance matrix in the candidate scene, and the mean vector and the covariance matrix of the sound samples is above the third preset threshold, then it will be determined that there are violent contents in the candidate scene, where the similarity between the mean vector and the covariance matrix in the candidate scene, and the mean vector and the covariance matrix of the sound sample can be calculated as in the prior art, so a repeated description thereof will be omitted here; and the third preset threshold can be preset empirically, for example, the value of the third preset threshold is 90.

In a possible implementation, in the method according to the embodiment of the disclosure, the audio feature data include an energy entropy of the audio data; and when the feature data of the elements include the audio feature data in the scene, then it will be determined whether the audio feature data in the scene lie in a range of audio feature data extracted in advance from the specific scene by segmenting the audio data in the scene into a number of segments, calculating an energy entropy of each segment of audio data, and when the energy entropy of at least one segment of audio data among the energy entropies of the segments of audio data is below a fourth preset threshold, then determining that the audio feature data in the scene lie in the range of audio feature data extracted in advance from the specific scene.

The audio data will be analyzed by analyzing some special sound in the scene. Many scenes including violent contents, e.g., striking, firing, exploding, etc., are generally accompanied by some special sound, and these scenes tend to happen in an extremely short period of time while bursting out some sound suddenly. In view of this, a sudden variation of the energy of a sound signal can be used as a further criterion to detect violent contents in the scene. In order to measure effectively this feature, an “energy entropy” rule is applied.

Particularly firstly the audio data in the candidate scene are segmented into several segments, and the energy of a sound signal in each segment is calculated, and normalized by being divided by the total energy of the audio data. The energy entropy of each segment of audio data is calculated in the equation of:

$$I = - {\sum }_{i = 1}^{J} {σ}_{i}^{2} {log}_{2} {σ}_{i}^{2} ,$$

Where I represents the energy entropy of each segment of audio data, J represents the total number of segments into which the audio data in the candidate scene are segmented, and σ² represents a normalized energy value of the i-th segment of audio data.

As can be apparent from the calculation of the energy entropy, the value of the energy entropy of the audio data can reflect a variation of the energy of a sound signal, where there is a high energy entropy of audio data with substantially constant energy, and there is a low energy entropy of audio data with varying sound energy, where there is a lower energy entropy of audio data with a less variation of the energy thereof. If there are audio data with the energy entropy thereof below a fourth preset threshold among the audio data in the scene, then it will be determined that there are violent contents in the scene, where the fourth preset threshold can be preset empirically, for example, the value of the fourth preset threshold is 6.

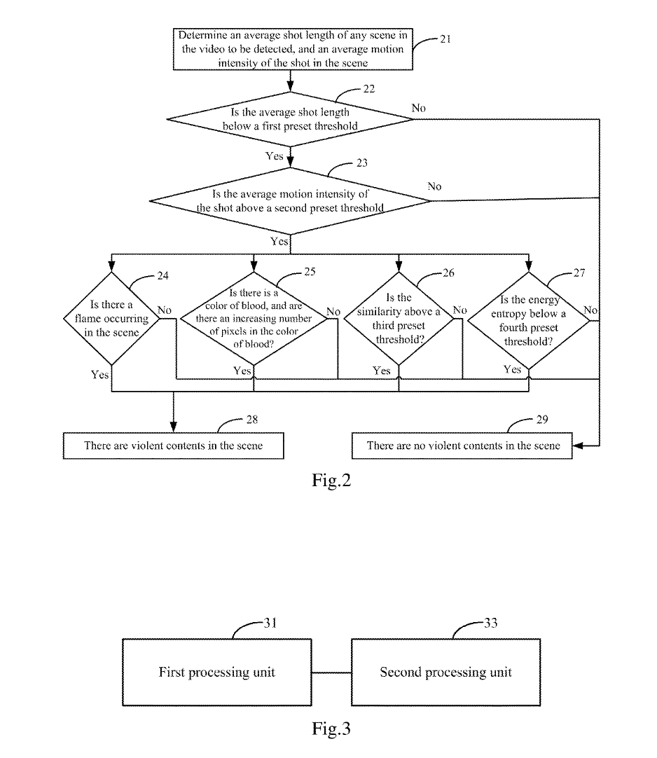

Particular steps in a method for detecting violent contents in a video according to an embodiment of the disclosure will be described below with reference to FIG. 2, and as illustrated in FIG. 2, the method includes:

The step 21 is to determine the average shot length of any scene in the video to be detected, and the average motion intensity of the shot in the scene;

The step 22 is to determine whether the average shot length is below a first preset threshold, and if so, to proceed to the step 23; otherwise, to proceed to the step 29, where the first preset threshold is preset empirically, for example, the value of the first preset threshold is 3;

The step 23 is to determine whether the average motion intensity of the shot is above a second preset threshold, and if so, to proceed to the step 24 and/or the step 25 and/or the step 27; otherwise, to proceed to the step 29, where the second preset threshold is preset empirically, for example, the value of the second preset threshold is ⅙ of the area of a picture; and of course, those skilled in the art shall appreciate that the step 22 and the step 23 can be performed in a reversed order in another embodiment of the disclosure.

The step 24 is to determine whether there is a flame occurring in the scene, particularly by comparing a color histogram of each frame of picture in the scene with a predefined color template, determining whether the counted amount of the yellow, orange, or red color in the color histogram of the scene lies in a range of counted amount of the corresponding color in the predefined color template, and if so, to proceed to the step 28; otherwise, to proceed to the step 29;

The step 25 is to determine whether there is a color of blood in the scene, and there are an increasing number of pixels in the color of blood, particularly by determining from the color histogram whether there is the color of blood in the scene, counting the numbers of pixels in the color of blood in a number of consecutive frames of pictures, determining whether the number of pixels in the color of blood is increasing gradually in a time order of the frames of pictures, and if there is a color of blood in the scene, and there are an increasing number of pixels in the color of blood, to proceed to the step 28; otherwise, to proceed to the step 29;

The step 26 is to determine whether the similarity between audio data in the scene, and sound sample is above a third preset threshold, particularly by determining whether the similarity between the audio data in the scene, and the sound sample is above the third preset threshold, using the similarity between a sample vector and a covariance matrix of the audio data in the scene, and a sample vector and a covariance matrix of the sound sample, and if so, to proceed to the step 28; otherwise, to proceed to the step 29, where the third preset threshold is preset empirically, for example, the value of the third preset threshold is 90;

The step 27 is to determine whether there is a segment with an energy entropy below a fourth preset threshold among the audio data in the scene, and if so, to proceed to the step 28; otherwise, to proceed to the step 29, where the fourth preset threshold is preset empirically, for example, the value of the fourth preset threshold is 6;

The step 28 is to determine that there are violent contents in the current scene, that is, there are violent contents in the video to be detected, if a result of the determination in at least one of the step 24, the step 25, the step 26, and the step 27 is positive; and

The step 29 is to determine that there are no violent contents in the current scene, that is, there are no violent contents in the video to be detected, if the result of the determination in the step 22 is negative, or the result of the determination in the step 23 is negative, or all the results of the determination in the step 22, the step 25, the step 26, and the step 27 are negative.

In the embodiments of the disclosure, firstly the average shot length of any scene in the video to be detected, and the average motion intensity of the shot in the scene are determined; the feature data of the elements in the scene are further extracted upon determining that the average shot length is below the first preset threshold, and/or the average motion intensity of the shot is above the second preset threshold, and particularly the color histogram of each frame of image in the scene, the sample vector and the covariance matrix of the audio data, and the energy entropy of the audio data are extracted; and it is determined that there are violent contents in the video to be detected upon determining that the feature data of at least one element among the extracted feature data of the elements lie in the range of feature data of the element extracted in advance from the specific scene (e.g., a violent scene), so that violent contents can be detected with respect to the feature data of the elements in the scene to thereby improve the accuracy of detecting violent contents in the video.

An embodiment of the disclosure provides an apparatus for detecting violent contents in a video as illustrated in FIG. 3, where the apparatus includes: a first processing unit 31 configured to determine the shot average length of any scene in the video to be detected, and the average motion intensity of the shot in the scene; and a second processing unit 33 configured to extract feature data of a number of elements in the scene upon determining that the average shot length is below a first preset threshold, and/or the average motion intensity of the shot is above a second preset threshold, and to determine that there are violent contents in the video to be detected upon determining that the feature data of at least one element among the extracted feature data of the elements lie in a range of feature data of the element extracted in advance from a specific scene.

In the apparatus according to the embodiment of the disclosure, firstly the average shot length of any scene in the video to be detected, and the average motion intensity of the shot in the scene are determined; the feature data of the elements in the scene are further extracted upon determining that the average shot length is below the first preset threshold, and/or the average motion intensity of the shot is above the second preset threshold; and it is determined that there are violent contents in the video to be detected upon determining that the feature data of at least one element among the extracted feature data of the elements lie in the range of feature data of the element extracted in advance from the specific scene (e.g., a violent scene). As compared with the prior art in which violent contents are detected based upon the average motion amount and duration of the video, or by analyzing the sound track, the feature data of the elements in the scene are extracted, and it is determined that there are violent contents in the video to be detected upon determining that the feature data of at least one element among the extracted feature data of the elements lie in the range of feature data of the element extracted in advance from the specific scene (e.g., a violent scene), so that violent contents can be detected with respect to the feature data of the elements in the scene to thereby improve the accuracy of detecting violent contents in the video.

In a possible implementation, in the apparatus according to the embodiment of the disclosure, the feature data of the elements include image feature data of each frame of picture in the scene, and audio feature data in the scene.

In a possible implementation, in the apparatus according to the embodiment of the disclosure, the image feature data of each frame of picture include a color histogram of each frame of picture; and when the feature data of the elements include the image feature data of each frame of picture in the scene, then the second processing unit 33 configured to determine whether the image feature data of each frame of picture lie in a range of image feature data of the picture extracted in advance from the specific scene is configured to extract for each frame of picture in the scene the color histogram of the frame of picture, and to determine that the image feature data of the frame of picture lie in the range of image feature data of the picture extracted in advance from the specific scene upon determining that the counted amounts of a preset number of colors in the color histogram of the frame of picture lie in ranges of counted amounts of the corresponding colors in a color histogram of the picture extracted from the specific scene.

In a possible implementation, in the apparatus according to the embodiment of the disclosure, after the second processing unit 33 determines that the counted amounts of the preset number of colors in the color histogram of the frame of picture lie in the ranges of counted amounts of the corresponding colors in the color histogram of the picture extracted from the specific scene, the second processing unit 33 is further configured to determine the counted amounts of the preset number of colors in a number of frames of pictures adjacent to the frame of picture; and the second processing unit 33 configured to determine that the image feature data of the frame of picture lie in the range of image feature data of the picture extracted in advance from the specific scene is configured to determine that the image feature data of the frame of picture lie in the range of image feature data of the picture extracted in advance from the specific scene upon determining that the counted number of each one of the preset number of colors in the frame of picture and the adjacent frames of pictures is increasing gradually in a time order of the frames of pictures.

In a possible implementation, in the apparatus according to the embodiment of the disclosure, the audio feature data include a sample vector and a covariance matrix of the audio data; and when the feature data of the elements include the audio feature data in the scene, then the second processing 33 configured to determine whether the audio feature data in the scene lie in a range of audio feature data extracted in advance from the specific scene is configured to calculate the sample vector and the covariance matrix of the audio data in the scene, and to determine that the audio feature data in the scene lie in the range of audio feature data extracted in advance from the specific scene upon determining that the similarity between the sample vector and the covariance matrix of the audio data in the scene, and a sample vector and a covariance matrix of the audio data extracted in advance from the specific scene is above a third preset threshold.

In a possible implementation, in the apparatus according to the embodiment of the disclosure, the audio feature data include an energy entropy of the audio data; and when the feature data of the elements include the audio feature data in the scene, then the second processing unit 33 configured to determine whether the audio feature data in the scene lie in a range of audio feature data extracted in advance from the specific scene is configured to segment the audio data in the scene into a number of segments, to calculate an energy entropy of each segment of audio data, and when the energy entropy of at least one segment of audio data among the energy entropies of the segments of audio data is below a fourth preset threshold, to determine that the audio feature data in the scene lie in the range of audio feature data extracted in advance from the specific scene.

In a possible implementation, in the apparatus according to the embodiment of the disclosure, the second processing unit 33 is configured to calculate the energy entropy of each segment of audio data in the equation of:

$$I = - {\sum }_{i = 1}^{J} {σ}_{i}^{2} {log}_{2} {σ}_{i}^{2} ,$$

Where I represents the energy entropy of each segment of audio data, J represents a total number of segments into which the audio data in the scene are segmented, and σ² represents a normalized energy value of the i-th segment of audio data.

In a possible implementation, in the apparatus according to the embodiment of the disclosure, the average motion intensity of the shot is equal to the ratio of the sum of motion intensities of all the shots in the scene to the total number of shots in the scene, where the first processing unit 31 is configured to calculate the motion intensity of each shot in the scene in the equation of:

$$SS = \frac{1}{T} {\sum }_{i = b + 1}^{e} \{ {\sum }_{m , n} \vert {m}_{l}^{k} ( m , n ) \vert \} ,$$

Where SS represents the motion intensity of each shot, mₗ^{k}(m,n) represents the i-th frame in the k-th shot of motion sequence images of the current scene, where m and n represent horizontal and vertical resolutions of the motion sequence images, b and e represent start frame number and end frame number of the k-th scene, and T represents the length T=e−b of the k-th shot.

In a possible implementation, in the apparatus according to the embodiment of the disclosure, the average length of the shot is equal to the ratio of the total length of time of the scene to the number of shots in the scene.

An embodiment of the disclosure provides an apparatus for detecting violent contents in a video, which can be integrated in video software to detect violent contents in a video, where both the first processing unit 31 and the second processing unit 33 can be embodied as a CPU processor, etc.

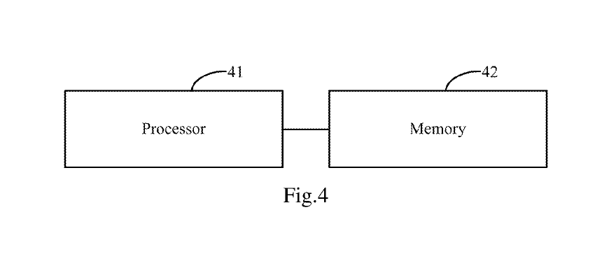

As illustrated in FIG. 4 which is a schematic structural diagram of an electronic device according to some embodiments, the electronic device includes:

at least one processor 41; and

a memory 42 communicably connected with the at least one processor for storing instructions executable by the at least one processor, wherein execution of the instructions by the at least one processor causes the at least one processor to:

determine an average shot length of any scene in the video to be detected, and an average motion intensity of a shot in the scene; and

extract feature data of a number of elements in the scene upon determining that the average shot length is below a first preset threshold, and/or the average motion intensity of the shot is above a second preset threshold, and determine that there are violent contents in the video to be detected upon determining that the feature data of at least one element among the extracted feature data of the elements lie in a range of feature data of the element extracted in advance from a specific scene.

In some embodiments, the feature data of the elements comprise image feature data of each frame of picture in the scene, and audio feature data in the scene.

In some embodiments, the image feature data of each frame of picture comprise a color histogram of each frame of picture; and

when the feature data of the elements comprise the image feature data of each frame of picture in the scene, then determine whether the image feature data of each frame of picture lie in a range of image feature data of the picture extracted in advance from the specific scene comprises:

for each frame of picture in the scene, extract the color histogram of the frame of picture, and determine that the image feature data of the frame of picture lie in the range of image feature data of the picture extracted in advance from the specific scene upon determining that counted amounts of a preset number of colors in the color histogram of the frame of picture lie in ranges of counted amounts of the corresponding colors in a color histogram of the picture extracted from the specific scene.

In some embodiments, wherein after it is determined that the counted amounts of the preset number of colors in the color histogram of the frame of picture lie in the ranges of counted amounts of the corresponding colors in the color histogram of the picture extracted from the specific scene, the at least one processor is further caused to:

determine the counted amounts of the preset number of colors in a number of frames of pictures adjacent to the frame of picture; and

determine that the image feature data of the frame of picture lie in the range of image feature data of the picture extracted in advance from the specific scene comprises:

determine that the image feature data of the frame of picture lie in the range of image feature data of the picture extracted in advance from the specific scene upon determining that the counted number of each one of the preset number of colors in the frame of picture and the adjacent frames of pictures is increasing gradually along a time order of the frames of pictures.

In some embodiments, the audio feature data comprise a sample vector of the audio data and a covariance matrix of the audio data; and

when the feature data of the elements comprise the audio feature data in the scene, then determine whether the audio feature data in the scene lie in a range of audio feature data extracted in advance from the specific scene comprises:

calculate the sample vector and the covariance matrix of the audio data in the scene, and determine that the audio feature data in the scene lie in the range of audio feature data extracted in advance from the specific scene upon determining that the similarity between the sample vector and the covariance matrix of the audio data in the scene, and a sample vector and a covariance matrix of the audio data extracted in advance from the specific scene is above a third preset threshold.

In some embodiments, the audio feature data comprise an energy entropy of the audio data; and

when the feature data of the elements comprise the audio feature data in the scene, then determine whether the audio feature data in the scene lie in a range of audio feature data extracted in advance from the specific scene comprises:

segment the audio data in the scene into a number of segments, calculating an energy entropy of each segment of audio data, and when the energy entropy of at least one segment of audio data among the energy entropies of the segments of audio data is below a fourth preset threshold, then determine that the audio feature data in the scene lie in the range of audio feature data extracted in advance from the specific scene.

In some embodiments, the energy entropy of each segment of audio data is calculated in the equation of:

$$I = - {\sum }_{i = 1}^{J} {σ}_{i}^{2} {log}_{2} {σ}_{i}^{2} ,$$

wherein I represents the energy entropy of each segment of audio data, J represents a total number of segments into which the audio data in the scene are segmented, and σ² represents a normalized energy value of the i-th segment of audio data.

In some embodiments, the average motion intensity of the shot is equal to a ratio of a sum of motion intensities of all the shots in the scene to a total number of shots in the scene, wherein the motion intensity of each shot in the scene is calculated in the equation of:

$$SS = \frac{1}{T} {\sum }_{i = b + 1}^{e} \{ {\sum }_{m , n} \vert {m}_{l}^{k} ( m , n ) \vert \} ,$$

wherein SS represents the motion intensity of each shot, mₗ^{k}(m,n) represents the i-th frame in the k-th shot of motion sequence images of the current scene, wherein m and n represent horizontal and vertical resolutions of the motion sequence images, b and e represent start frame number and end frame number of the k-th shot, and T represents a length T=e−b of the k-th shot.

In some embodiments, the average shot length is equal to a ratio of a total length of time of the scene to a number of shots in the scene.

An embodiment of the disclosure provides a non-transitory computer-readable storage medium storing executable instructions that, when executed by an electronic device with a touch-sensitive display, cause the electronic device to:

determine an average shot length of any scene in the video to be detected, and an average motion intensity of a shot in the scene; and

extract feature data of a number of elements in the scene upon determining that the average shot length is below a first preset threshold, and/or the average motion intensity of the shot is above a second preset threshold, and determine that there are violent contents in the video to be detected upon determining that the feature data of at least one element among the extracted feature data of the elements lie in a range of feature data of the element extracted in advance from a specific scene.

In some embodiments, the feature data of the elements comprise image feature data of each frame of picture in the scene, and audio feature data in the scene.

the image feature data of each frame of picture comprise a color histogram of each frame of picture; and

when the feature data of the elements comprise the image feature data of each frame of picture in the scene, then determine whether the image feature data of each frame of picture lie in a range of image feature data of the picture extracted in advance from the specific scene comprises:

for each frame of picture in the scene, extract the color histogram of the frame of picture, and determine that the image feature data of the frame of picture lie in the range of image feature data of the picture extracted in advance from the specific scene upon determining that counted amounts of a preset number of colors in the color histogram of the frame of picture lie in ranges of counted amounts of the corresponding colors in a color histogram of the picture extracted from the specific scene.

After it is determined that the counted amounts of the preset number of colors in the color histogram of the frame of picture lie in the ranges of counted amounts of the corresponding colors in the color histogram of the picture extracted from the specific scene, the non-transitory computer-readable storage medium further cause the electronic device to:

determine the counted amounts of the preset number of colors in a number of frames of pictures adjacent to the frame of picture; and

determine that the image feature data of the frame of picture lie in the range of image feature data of the picture extracted in advance from the specific scene comprises:

determine that the image feature data of the frame of picture lie in the range of image feature data of the picture extracted in advance from the specific scene upon determining that the counted number of each one of the preset number of colors in the frame of picture and the adjacent frames of pictures is increasing gradually along a time order of the frames of pictures.

In some embodiments, the audio feature data comprise a sample vector of the audio data and a covariance matrix of the audio data; and

when the feature data of the elements comprise the audio feature data in the scene, then determine whether the audio feature data in the scene lie in a range of audio feature data extracted in advance from the specific scene comprises:

calculate the sample vector and the covariance matrix of the audio data in the scene, and determine that the audio feature data in the scene lie in the range of audio feature data extracted in advance from the specific scene upon determining that the similarity between the sample vector and the covariance matrix of the audio data in the scene, and a sample vector and a covariance matrix of the audio data extracted in advance from the specific scene is above a third preset threshold.

In some embodiments, the audio feature data comprise an energy entropy of the audio data; and

when the feature data of the elements comprise the audio feature data in the scene, then determine whether the audio feature data in the scene lie in a range of audio feature data extracted in advance from the specific scene comprises:

segment the audio data in the scene into a number of segments, calculating an energy entropy of each segment of audio data, and when the energy entropy of at least one segment of audio data among the energy entropies of the segments of audio data is below a fourth preset threshold, then determine that the audio feature data in the scene lie in the range of audio feature data extracted in advance from the specific scene.

In some embodiments, the energy entropy of each segment of audio data is calculated in the equation of:

$$I = - {\sum }_{i = 1}^{J} {σ}_{i}^{2} {log}_{2} {σ}_{i}^{2} ,$$

wherein I represents the energy entropy of each segment of audio data, J represents a total number of segments into which the audio data in the scene are segmented, and σ² represents a normalized energy value of the i-th segment of audio data.

In some embodiments, the average motion intensity of the shot is equal to a ratio of a sum of motion intensities of all the shots in the scene to a total number of shots in the scene, wherein the motion intensity of each shot in the scene is calculated in the equation of:

$$SS = \frac{1}{T} {\sum }_{i = b + 1}^{e} \{ {\sum }_{m , n} \vert {m}_{l}^{k} ( m , n ) \vert \} ,$$

wherein SS represents the motion intensity of each shot, mₗ^{k}(m,n) represents the i-th frame in the k-th shot of motion sequence images of the current scene, wherein m and n represent horizontal and vertical resolutions of the motion sequence images, b and e represent start frame number and end frame number of the k-th shot, and T represents a length T=e−b of the k-th shot.

In some embodiments, the average shot length is equal to a ratio of a total length of time of the scene to a number of shots in the scene.

In the method and device, and the storage medium according to the embodiments of the disclosure, firstly the average shot length of any scene in the video to be detected, and the average motion intensity of the shot in the scene are determined; the feature data of the elements in the scene are further extracted upon determining that the average shot length is below the first preset threshold, and/or the average motion intensity of the shot is above the second preset threshold; and it is determined that there are violent contents in the video to be detected upon determining that the feature data of at least one element among the extracted feature data of the elements lie in the range of feature data of the element extracted in advance from the specific scene (e.g., a violent scene), so that violent contents can be detected with respect to the feature data of the elements in the scene to thereby improve the accuracy of detecting violent contents in the video.

The electronic device according to some embodiments of the disclosure can be in multiple forms, which include but not limit to:

1. Mobile communication device, of which characteristic has mobile communication function, and briefly acts to provide voice and data communication. These terminals include smart pone (i.e. iPhone), multimedia mobile phone, feature phone, cheap phone and etc.

2. Ultra mobile personal computing device, which belongs to personal computer, and has function of calculation and process, and has mobile networking function in general. These terminals include PDA, MID, UMPC (Ultra Mobile Personal Computer) and etc.

3. Portable entertainment equipment, which can display and play multimedia contents. These equipments include audio player, video player (e.g. iPod), handheld game player, electronic book, hobby robot and portable vehicle navigation device.

4. Server, which provides computing services, and includes processor, hard disk, memory, system bus and etc. The framework of the server is similar to the framework of universal computer, however, there is a higher requirement for processing capacity, stability, reliability, safety, expandability, manageability and etc due to supply of high reliability services.

5. Other electronic devices having data interaction function.

The embodiments of the apparatuses described above are merely exemplary, where the units described as separate components may or may not be physically separate, and the components illustrated as elements may or may not be physical units, that is, they can be collocated or can be distributed onto a number of network elements. A part or all of the modules can be selected as needed in reality for the purpose of the solution according to the embodiments of the disclosure.

Those skilled in the art can clearly appreciate from the foregoing description of the embodiments that the embodiments of the disclosure can be implemented in hardware or in software plus a necessary general hardware platform. Based upon such understanding, the technical solutions above essentially or their parts contributing to the prior art can be embodied in the form of a computer software product which can be stored in a computer readable storage medium, e.g., an ROM/RAM, a magnetic disk, an optical disk, etc., and which includes several instructions to cause a computer device (e.g., a personal computer, a server, a network device, etc.) to perform the method according to the respective embodiments of the disclosure.

Lastly it shall be noted that the embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

What is claimed is:

1. A method for detecting violent contents in a video, the method comprising:
at an electronic device:
determining an average shot length of any scene in the video to be detected, and an average motion intensity of a shot in the scene; and
extracting feature data of a number of elements in the scene upon determining that the average shot length is below a first preset threshold, and/or the average motion intensity of the shot is above a second preset threshold, and determining that there are violent contents in the video to be detected upon determining that the feature data of at least one element among the extracted feature data of the elements lie in a range of feature data of the element extracted in advance from a specific scene.

2. The method according to claim 1, wherein the feature data of the elements comprise image feature data of each frame of picture in the scene, and audio feature data in the scene.

3. The method according to claim 2, wherein the image feature data of each frame of picture comprise a color histogram of each frame of picture; and
when the feature data of the elements comprise the image feature data of each frame of picture in the scene, then determining whether the image feature data of each frame of picture lie in a range of image feature data of the picture extracted in advance from the specific scene comprises:
for each frame of picture in the scene, extracting the color histogram of the frame of picture, and determining that the image feature data of the frame of picture lie in the range of image feature data of the picture extracted in advance from the specific scene upon determining that counted amounts of a preset number of colors in the color histogram of the frame of picture lie in ranges of counted amounts of the corresponding colors in a color histogram of the picture extracted from the specific scene.

4. The method according to claim 3, wherein after it is determined that the counted amounts of the preset number of colors in the color histogram of the frame of picture lie in the ranges of counted amounts of the corresponding colors in the color histogram of the picture extracted from the specific scene, the method further comprises:
determining the counted amounts of the preset number of colors in a number of frames of pictures adjacent to the frame of picture; and
determining that the image feature data of the frame of picture lie in the range of image feature data of the picture extracted in advance from the specific scene comprises:
determining that the image feature data of the frame of picture lie in the range of image feature data of the picture extracted in advance from the specific scene upon determining that the counted number of each one of the preset number of colors in the frame of picture and the adjacent frames of pictures is increasing gradually along a time order of the frames of pictures.

5. The method according to claim 2, wherein the audio feature data comprise a sample vector of the audio data and a covariance matrix of the audio data; and
when the feature data of the elements comprise the audio feature data in the scene, then determining whether the audio feature data in the scene lie in a range of audio feature data extracted in advance from the specific scene comprises:
calculating the sample vector and the covariance matrix of the audio data in the scene, and determining that the audio feature data in the scene lie in the range of audio feature data extracted in advance from the specific scene upon determining that the similarity between the sample vector and the covariance matrix of the audio data in the scene, and a sample vector and a covariance matrix of the audio data extracted in advance from the specific scene is above a third preset threshold.

6. The method according to claim 2, wherein the audio feature data comprise an energy entropy of the audio data; and
when the feature data of the elements comprise the audio feature data in the scene, then determining whether the audio feature data in the scene lie in a range of audio feature data extracted in advance from the specific scene comprises:
segmenting the audio data in the scene into a number of segments, calculating an energy entropy of each segment of audio data, and when the energy entropy of at least one segment of audio data among the energy entropies of the segments of audio data is below a fourth preset threshold, then determining that the audio feature data in the scene lie in the range of audio feature data extracted in advance from the specific scene.

7. The method according to claim 6, wherein the energy entropy of each segment of audio data is calculated in the equation of:
$$I = - {\sum }_{i = 1}^{J} {σ}_{i}^{2} {log}_{2} {σ}_{i}^{2} ,$$
wherein I represents the energy entropy of each segment of audio data, J represents a total number of segments into which the audio data in the scene are segmented, and σ² represents a normalized energy value of the i-th segment of audio data.

8. The method according to claim 1, wherein the average motion intensity of the shot is equal to a ratio of a sum of motion intensities of all the shots in the scene to a total number of shots in the scene, wherein the motion intensity of each shot in the scene is calculated in the equation of:
$$SS = \frac{1}{T} {\sum }_{i = b + 1}^{e} \{ {\sum }_{m , n} \vert {m}_{l}^{k} ( m , n ) \vert \} ,$$
wherein SS represents the motion intensity of each shot, mₗ^{k}(m,n) represents the i-th frame in the k-th shot of motion sequence images of the current scene, wherein m and n represent horizontal and vertical resolutions of the motion sequence images, b and e represent start frame number and end frame number of the k-th shot, and T represents a length T=e−b of the k-th shot.

9. The method according to claim 1, wherein the average shot length is equal to a ratio of a total length of time of the scene to a number of shots in the scene.

10. An electronic device, comprising:
at least one processor; and
a memory communicably connected with the at least one processor for storing instructions executable by the at least one processor, wherein execution of the instructions by the at least one processor causes the at least one processor to:
determine an average shot length of any scene in the video to be detected, and an average motion intensity of a shot in the scene; and
extract feature data of a number of elements in the scene upon determining that the average shot length is below a first preset threshold, and/or the average motion intensity of the shot is above a second preset threshold, and determine that there are violent contents in the video to be detected upon determining that the feature data of at least one element among the extracted feature data of the elements lie in a range of feature data of the element extracted in advance from a specific scene.

11. The electronic device according to claim 10, wherein the feature data of the elements comprise image feature data of each frame of picture in the scene, and audio feature data in the scene.

12. The electronic device according to claim 11, wherein the image feature data of each frame of picture comprise a color histogram of each frame of picture; and
when the feature data of the elements comprise the image feature data of each frame of picture in the scene, then determine whether the image feature data of each frame of picture lie in a range of image feature data of the picture extracted in advance from the specific scene comprises:
for each frame of picture in the scene, extract the color histogram of the frame of picture, and determine that the image feature data of the frame of picture lie in the range of image feature data of the picture extracted in advance from the specific scene upon determining that counted amounts of a preset number of colors in the color histogram of the frame of picture lie in ranges of counted amounts of the corresponding colors in a color histogram of the picture extracted from the specific scene.

13. The electronic device according to claim 12, wherein after it is determined that the counted amounts of the preset number of colors in the color histogram of the frame of picture lie in the ranges of counted amounts of the corresponding colors in the color histogram of the picture extracted from the specific scene, the at least one processor is further caused to:
determine the counted amounts of the preset number of colors in a number of frames of pictures adjacent to the frame of picture; and
determine that the image feature data of the frame of picture lie in the range of image feature data of the picture extracted in advance from the specific scene comprises:
determine that the image feature data of the frame of picture lie in the range of image feature data of the picture extracted in advance from the specific scene upon determining that the counted number of each one of the preset number of colors in the frame of picture and the adjacent frames of pictures is increasing gradually along a time order of the frames of pictures.

14. The electronic device according to claim 11, wherein the audio feature data comprise a sample vector of the audio data and a covariance matrix of the audio data; and
when the feature data of the elements comprise the audio feature data in the scene, then determine whether the audio feature data in the scene lie in a range of audio feature data extracted in advance from the specific scene comprises:
calculate the sample vector and the covariance matrix of the audio data in the scene, and determine that the audio feature data in the scene lie in the range of audio feature data extracted in advance from the specific scene upon determining that the similarity between the sample vector and the covariance matrix of the audio data in the scene, and a sample vector and a covariance matrix of the audio data extracted in advance from the specific scene is above a third preset threshold.

15. The electronic device according to claim 11, wherein the audio feature data comprise an energy entropy of the audio data; and
when the feature data of the elements comprise the audio feature data in the scene, then determine whether the audio feature data in the scene lie in a range of audio feature data extracted in advance from the specific scene comprises:
segment the audio data in the scene into a number of segments, calculating an energy entropy of each segment of audio data, and when the energy entropy of at least one segment of audio data among the energy entropies of the segments of audio data is below a fourth preset threshold, then determine that the audio feature data in the scene lie in the range of audio feature data extracted in advance from the specific scene.

16. The electronic device according to claim 15, wherein the energy entropy of each segment of audio data is calculated in the equation of:
$$I = - {\sum }_{i = 1}^{J} {σ}_{i}^{2} {log}_{2} {σ}_{i}^{2} ,$$
wherein I represents the energy entropy of each segment of audio data, J represents a total number of segments into which the audio data in the scene are segmented, and σ² represents a normalized energy value of the i-th segment of audio data.

17. The electronic device according to claim 10, wherein the average motion intensity of the shot is equal to a ratio of a sum of motion intensities of all the shots in the scene to a total number of shots in the scene, wherein the motion intensity of each shot in the scene is calculated in the equation of:
$$SS = \frac{1}{T} {\sum }_{i = b + 1}^{e} \{ {\sum }_{m , n} \vert {m}_{l}^{k} ( m , n ) \vert \} ,$$
wherein SS represents the motion intensity of each shot, mₗ^{k}(m,n) represents the i-th frame in the k-th shot of motion sequence images of the current scene, wherein m and n represent horizontal and vertical resolutions of the motion sequence images, b and e represent start frame number and end frame number of the k-th shot, and T represents a length T=e−b of the k-th shot.

18. The electronic device according to claim 10, wherein the average shot length is equal to a ratio of a total length of time of the scene to a number of shots in the scene.

19. A non-transitory computer-readable storage medium storing executable instructions that, when executed by an electronic device with a touch-sensitive display, cause the electronic device to:
determine an average shot length of any scene in the video to be detected, and an average motion intensity of a shot in the scene; and
extract feature data of a number of elements in the scene upon determining that the average shot length is below a first preset threshold, and/or the average motion intensity of the shot is above a second preset threshold, and determine that there are violent contents in the video to be detected upon determining that the feature data of at least one element among the extracted feature data of the elements lie in a range of feature data of the element extracted in advance from a specific scene.

20. The non-transitory computer-readable storage medium according to claim 19, wherein the feature data of the elements comprise image feature data of each frame of picture in the scene, and audio feature data in the scene.
